(19) United States
(12) Patent Application Publication
(10) Pub. No.: US 2017/0177889 A1
(43) Pub. Date: Jun. 22, 2017

(54) SECURITY OVERLAY FOR MANAGEMENT OF COMPUTER-AIDED DESIGN FILES

(71) Applicant: Applied Software Technology, Inc., Atlanta, GA (US)

(72) Inventor: Jason Faulkner, Atlanta, GA (US)

(21) Appl. No.: 14/972,076

(22) Filed: Dec. 16, 2015

(51) Int. Cl. G06F 21/62; G06F 9/44

(52) U.S. Cl. CPC G06F 21/6218; G06F 8/70; G06F 21/629

(57) ABSTRACT

Systems and methods presented herein provide a security overlay that provides project-based security to an existing computer-aided design management system that might not natively include project-based security options. The security overlay defines custom objects for projects and roles. Roles can be defined for users for particular projects and stored as mapping data within instances of project custom objects, the instances corresponding to the projects. Implementers of action event triggers can cause an enforcement method within the security overlay to apply the project-based security to various user actions. To identify the project to which an action object (e.g., file) corresponds, the enforcement method can search for an instance of a project custom object within a file path of the action object.

### BACKGROUND

Advanced construction modeling software such as AUTODESK AUTOCAD and INVENTOR allows users to create three-dimensional models for manufacturing and building projects. CAD and INVENTOR can be used as authoring tools by designers for designing buildings and components. Using other software, teams can review the model at the, such as on a mobile device. The visualization provided by the models may allow users to streamline inspections, workflow, coordination, and reporting. The files can also be modified as the project evolves, either in the design stages or in the implementation stages.

However, management of files associated with a computer-aid design (“CAD”) project can be limited to the options provided by the CAD file management system. For example, AUTODESK VAULT is a CAD file management system for version control of CAD files. AUTODESK VAULT assigns a set of permissions to a user account, which is global throughout the VAULT system. INVENTOR operates similarly.

This becomes a problem when customers want to allow limited access to certain project data on particular projects. For example, the customer may desire an “advisory” role in one project, or full access in another project that has a project manager. VAULT security cannot fulfill this need, because the user-based security is essentially global throughout the entire system. It does not allow for different user security between projects or stages of projects.

Because of specific implementation advantages that arise when using a CAD file management system with CAD projects, it may not be feasible to simply switch to a stand-alone file management system that has different security policies.

Therefore, based on at least these technology-specific problems, a need exists for a security overlay for CAD management systems, such as AUTODESK VAULT.

### SUMMARY

The examples described herein specifically address problems that arise in the technological context of security shortcomings in VAULT. The examples include a customizable security overlay that introduces a project concept to VAULT's folder-centric interface. The overlay can provide a data-driven interface that customers can configure specifically to their internal roles on a project-by-project basis.

In one example, a security overlay for enforcing project-based security in an existing computer-aided design management system creates a first custom object for defining projects and second custom object for defining project roles, the first and second custom objects being stored in the CAD file management system (e.g., VAULT). It also creates an instance of the first custom object to define a project. The security overlay can provide a user interface, where it receives input from an administrative user to define permitted roles for performing a plurality of state transitions within the project. The permitted roles are mapped to users and stored as mapping information associated to the first custom object.

When a user is using the computer-aided design management system and an event is generated in relation to an action object, an implementer contacts the security overlay. In response, the security overlay can execute an enforcement process, the enforcement process determining that the event correlates to the project by locating a link to the instance within a file path for the action object. Based on determining that the mapping information does not permit the event, the security overlay can send a custom restriction method to the computer-aided design management system based on at least one role within the permitted roles being associated with a user that triggered the event.

It is to be understood that both the foregoing general description and the following detailed description are exemplary and explanatory only and are not restrictive of the embodiments, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an exemplary illustration of system components for integrating a security overlay with VAULT;

FIG. 2 is an exemplary system diagram, in accordance with an embodiment;

FIGS. 3A and 3B are exemplary user interfaces;

FIGS. 4 and 5 are exemplary flow charts with non-exhaustive listings of steps, in accordance with an embodiment; and

FIG. 6 is an exemplary illustration of system components, in accordance with an embodiment.

### DESCRIPTION OF THE EMBODIMENTS

Reference will now be made in detail to the present exemplary embodiments, including examples illustrated in the accompanying drawings. Wherever possible, the same reference numbers will be used throughout the drawings to refer to the same or like parts. The described embodiments are all exemplary and non-limiting.

Exemplary systems herein implement a security overlay that provides project-based security to a user-based and folder-based CAD file management system. The security overlay can set project-specific role and user based file security, and can execute an enforcement process that can communicate with an application program interface (API) of the CAD file management system. The security overlay can be an application or a plugin to the CAD file management system.

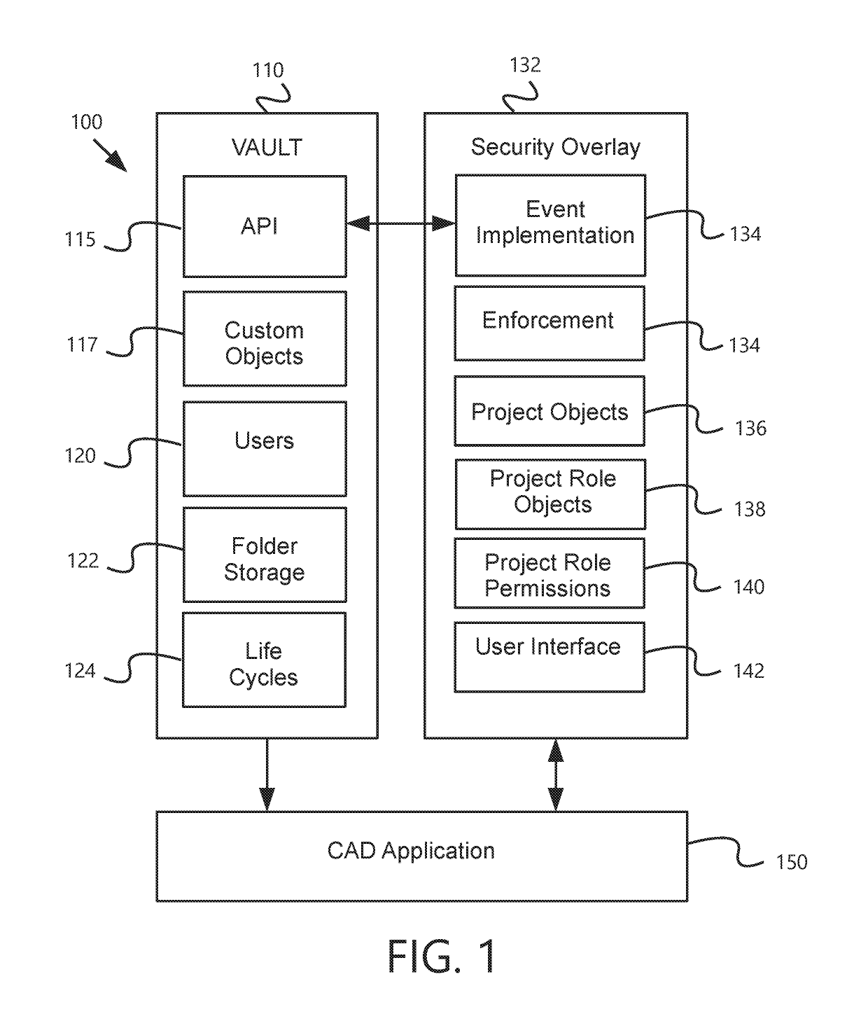

FIG. 1 includes an exemplary diagram of a system 100 in accordance with an example. VAULT 110, a CAD file management system, can interact with a security overlay application 132 and a CAD application 150. Although VAULT 110 is used as an example below, other CAD file management systems are possible. A CAD file management system can execute on a computing device, such as a server, to track versions of files that are part of a CAD project.

However, current CAD management systems including VAULT 110 do not allow for project-based permissions. Instead, global permissions (e.g., privileges) are assigned to each user. This means that a particular user will have the same permissions across all projects and files in the CAD management system.

In the native VAULT security model, users 120 and roles can be defined. Users 120 can be assigned to multiple roles, such as via groups, and be granted the privileges allowed by the assigned roles. Based on these global privileges, the user can open, edit, save, or create a CAD file within VAULT 110 for use in the CAD application 150. The user can also perform similar actions to metadata associated with the CAD file. However, the user can perform their assigned roles anywhere in the system. This can make it cumbersome to allow clients or particular users to view or modify projects within VAULT 110, as it may give the user access to other projects and files not affiliated with the user. The user can potentially manipulate CAD files or metadata in projects that they are not a member of.

VAULT 110 utilizes a folder storage 122 interface to access files, much like WINDOWS. Each object, such as a document, folder, file, or custom object, can be associated with user-defined life cycles 124. Life cycles 124 can include states for assignment to files. Example states can include “work in progress,” “under review,” “released,” and others. These states can control document security since roles can be defined to allow different actions based on the state. For example, for a particular state, a user role may permit read-only access, prevent file checkout, and/or prevent the user from changing the life cycle 124 to another state.

None of these standard VAULT 110 security measures include project-based security. To solve this issue, the security overlay 132 can execute as a plugin that introduces project-based permissions to the VAULT 110 system. This can allow users to manage files for CAD projects in VAULT 110 (or another CAD file management system) with project-based security even though it is not natively offered in VAULT 110. In an example, the security overlay 132 interacts with the VAULT 110 application programming interface (“API”) 115 to create and use custom objects 117 for security provisioning purposes.

Using the API 115, VAULT 110 can execute custom methods for the security overlay 132 when certain events occur within VAULT 110. These events can be pre events, post events, or restriction events. Pre events are generated when an action is submitted to a VAULT 110 server for performance by VAULT 110. Post events are called after the VAULT 110 server has performed the operation. Restriction events can occur prior to the pre event. The security overlay 132 can implement the restriction events to cause VAULT 110 to check with the security overlay 132 for imposing custom restrictions prior to the pre or post event occurring. If restrictions are provided by the security overlay 132, VAULT 110 can block the action and raise a message specified by the restriction implementation.

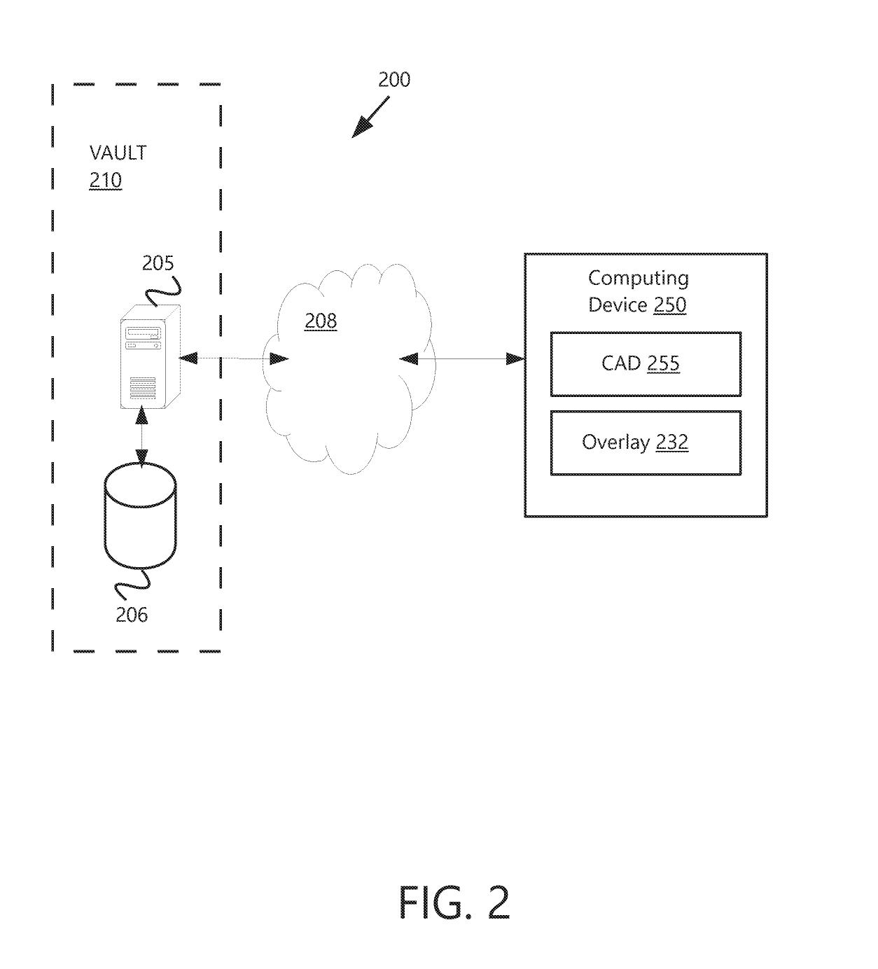

FIG. 2 shows an example system 200 where VAULT 210 executes on a server 205 with a database 206. A user can access VAULT with a computing device 250 over a network 208, such as a local area network or the Internet. The computing device 250 can execute CAD software 255 for visualizing CAD projects. For example, designers can create models in the CAD application 255 that are part of a project being carried out by multiple team members.

The CAD software 255 can open CAD files from VAULT 110. However, VAULT is configured to implement the security overlay 232, which controls what project-specific actions the user can take.

The server 205 can comprise one or more servers. For example, server 205 may include a plurality of servers located all over the world at locations convenient for communicating with devices in particular geographic locations. For simplicity, FIG. 2 illustrates only one server 205, but embodiments with multiple servers for one or more of the entities are contemplated.

The computing device 250 can be any processor-based device, such as a personal computer, laptop, tablet, or cell phone. It can also include or be part of server 205 in one example. Additionally, the computing device 250 or server 205 can execute the CAD application 255 or the CAD file management frontend by executing a set of instructions stored locally or remotely on a computer-readable medium. The computing device 250 can also execute the security overlay 232 in one example. In another example, the security overlay 232 can execute on the server 205.

Returning to FIG. 1, the security overlay 132 can be used by an administrative user to create a project-specific security overlay for VAULT 110. This requires three general stages. First, the security overlay 132 is used to define a security configuration. Then the security configuration is linked to a project. Finally, an enforcement 134 algorithm executes the security configuration for the project. These stages are discussed below in turn.

Setting Up a Security Configuration

Setting up a security configuration in the security overlay 132 for use with VAULT 110 includes creating custom objects 117 to store instances of project role objects 138, project objects 136, and project role permissions 140.

Custom objects 117 can be stored in VAULT 110, and contain metadata regarding the project roles 138, projects 136, and project role permissions 140. In one example, the security overlay 132 creates the custom objects 117 by utilizing API 115 calls to VAULT 110. Once the custom objects 117 are defined, the security overlay 132 can create as many instances as are needed. For example, a new instance of the project object 136 can be created for each project.

Each custom object 110 can define properties and corresponding values. These properties and values can be key-value pairs that specify a property named X contains a value Y. As an example, a custom object 110 called “Company” can have the following properties: company name, address, phone number, fax number, company short code. Another custom object called “Contact” can have the following properties: name, email, phone number, and company short code. The company short code can establish a link between the Contact object and the Company object. In this way, the custom objects 117 can be created and used to track related information.

Custom objects can further be assigned life cycles 124 similarly to other files in the VAULT 110 system. Life cycle 124 states of an instance of a custom object can define security for accessing, manipulating, or changing the state of that instance.

Custom objects 117 can reside in their own containers, separate from the folder storage 122 for other VAULT 110 files. For example, all Company objects can reside within a Company container. Through use of the VAULT 110 API 115, the security overlay 132 can link instances of custom objects 117 to a file folder 122, establishing a shortcut to the respective instance within the folder. This can allow the user or security overlay 132 to access a particular instance of a custom object by a shortcut link within the folder rather than having to navigate to the container that holds the custom objects. This can allow the user or security overlay 132 to organize custom object instances that are relevant to the particular folder content.

The security overlay 132 operates on top of the VAULT 110 security model to allow fine control over particular folder structures. In order to support a project data driven security implementation, the security overlay 132 can create various custom objects or ensure that those custom objects have already been created.

A first custom object can be a project role object 138. The project role object 138 can be used to define particular roles, such as “project manager” or “project engineer.” The properties can include “Role ID,” “Role Name,” and “Role Description.”

A second custom object can be a project object 136. The project object can define which VAULT 110 users 120 are assigned to which project role. The project object 136 can also define project-specific data. As an example, the project object 136 can include properties such as “Project Name,” “Project Number,” other project related properties, and project role to user mapping data.

The project role to user mapping data can be a single property value that is dynamically driven. It can contain all the relevant mapping information in a single string value. This can be done by concatenating all mapping data into a delimited string prior to saving the Project object 136 and expanding the mapping data prior to use.

The mapping data can be entered and edited by an administrative user in a user interface 142 that executes as part of the security overlay 132. The user interface 136 can extract the string of mapping data from the project object 136 to populate a user interface 142. The user can modify the mapping data and then save the modified mapping data back to the project object. The modified mapping data can be combined into a delimited string for storage in the instance of the project object 136. This mapping data can then be used by the security overlay 132 to enforce the project-based security rules.

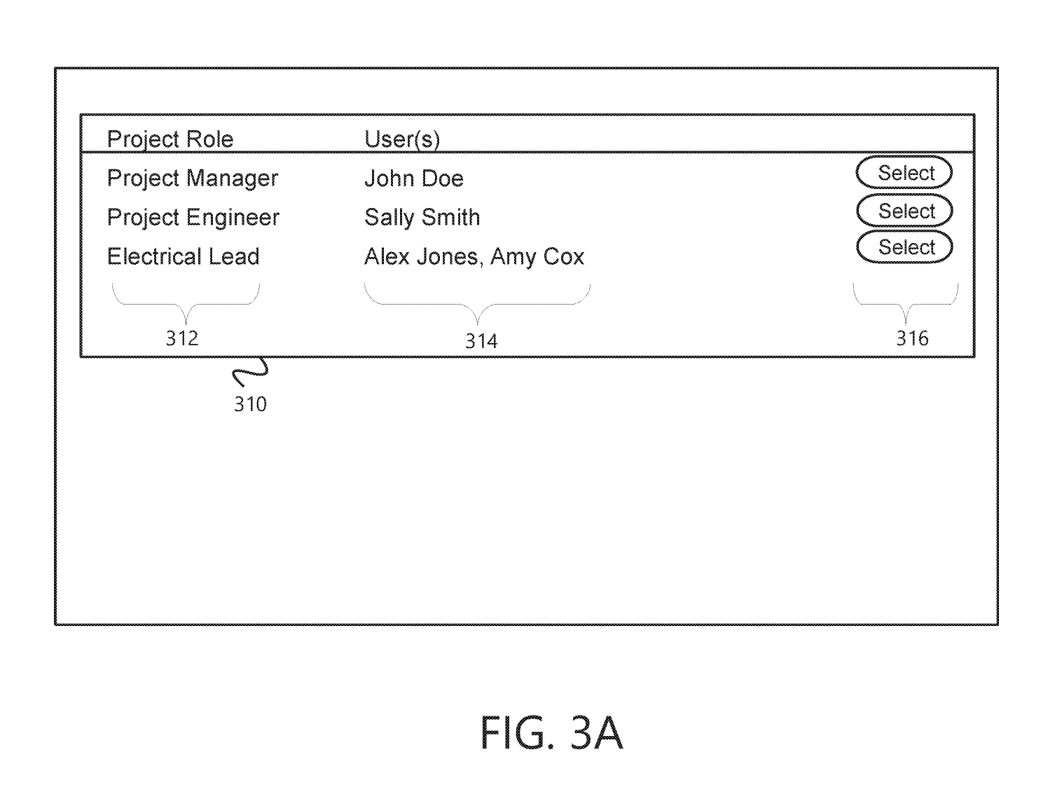

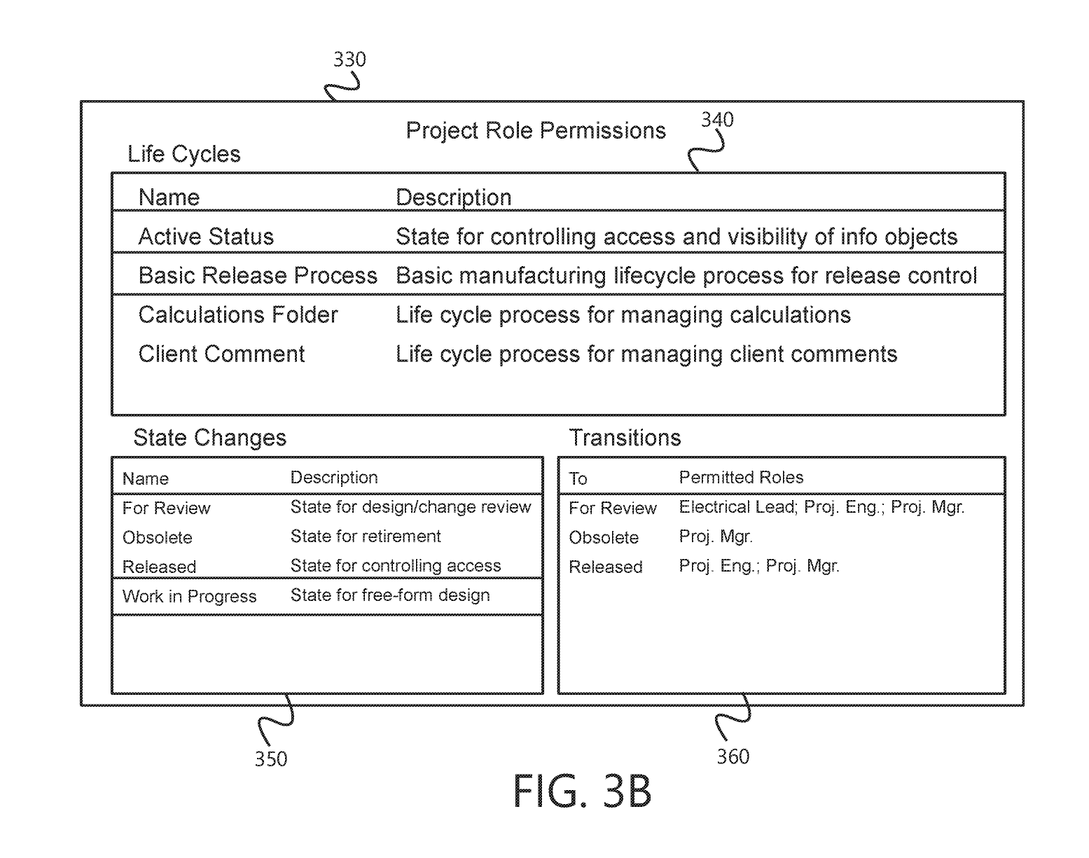

In one example, the administrative user sets up the available project roles and maps those to users that are defined in VAULT 110. Turning to FIG. 3A, an example user interface 310 for defining project roles in the security overlay 132 is presented. In this example, instances of the project role object 138 can be created to include: Project Manager, Project Engineer, and Electrical Lead. An administrative user can create additional roles by typing them into the Project Role column in one example.

Then, users 314 can be assigned to the roles. In this example, the administrative user can click a button 316 associated with a role to add one or more users to that role. The users can be retrieved from the user information stored in VAULT 110. In another example, roles can be assigned to users.

The administrative user can save the project role changes. Upon doing so, the security overlay 132 can ensure that an instance of the project role object 138 is created for each of the defined project roles 312. A concatenated text string linking users to project roles is also created and stored in the instance of the project object 136.

Next, the administrative user can define project role permissions by assigning role-specific privileges to states within life cycles. FIG. 3B includes an example user interface 330 for defining project role permissions. A life cycle pane 340 allows the administrative user to create and edit life cycles for different processes that can be relevant within projects. In this particular example, the administrative user or other user has created four different life cycles 124, including “Active Status,” “Basic Release Process,” “Calculations Folder,” and “Client Comment.”

By selecting one of the life cycles (in this example, “Basic Release Process”), the state changes pane 350 is populated. State changes represent different states that can exist for a file within a particular life cycle 124. Life cycles 124 and state changes can be setup initially in VAULT 110 in one example.

However, the security overlay 132 additionally provides the ability to define role-based transitions (a type of project role permissions 140) for the state changes for a particular project. The transitions 140 can be defined in transitions pane 360. This can allow an administrative user to specify which project roles are allowed to perform which transitions. In the example of FIG. 3B, only the project manager role users can transition from a current state “Work In Progress” (selected) to a transition state “Obsolete.” The transition from “Work In Progress” to “For Review” can be performed by any user that has a role in the group of electrical lead, project engineer, or project manager. The transition to “Released” can be performed by a user with a project engineer or project manager role.

Other VAULT 110 functions can also be controlled by customized transitions of the security overlay 132. These functions can include checkout, checkin, file download. Additional functions for which the security overlay 132 can define transitions include the ability to add, move, and delete files, folders, custom objects, or metadata associated with any of those object types.

The project role permissions defined in the transitions pane 360 can be stored in custom objects 117 in VAULT 110. The configuration data can be serialized and stored in a single string for future deserialization and use. The future uses include future project role permission editing in the user interface 330 of FIG. 3B, and enforcement of the security overlay 132, as will be further explained.

Associating a Project with the Security Overlay Security Configuration

Before the security settings can be enforced, a particular project within VAULT 110 must be associated with the security configuration of the security overlay 132. To do this, a project folder is linked to an instance of a project object 136. This link can be created at the root level of a project folder structure. By creating the link between the VAULT 110 project folder and the project object instance (which defines the users 120 associated with the project roles for that project), the security overlay permissions defined in the project role permissions are applied to the linked folder and its children.

Enforcing the Security Configuration

To enforce the security rules, an enforcement algorithm 134 that is part of the security overlay 132 can execute on VAULT 110 API 115 events. The API 115 is used to direct VAULT 110 to check the security configuration of the security overlay 132 for a particular project upon detecting particular events.

Table 1, below, includes an example list of VAULT 110 events that can invoke the enforcement algorithm of the security overlay 132.

TABLE 1

UpdateFileLifecycleStateEvents.GetRestrictions
UpdateCustomEntityLifecycleStateEvents.GetRestrictions
CheckoutFileEvents.GetRestrictions
CheckinFileEvents.GetRestrictions
DownloadFileEvents.GetRestrictions
AddFileEvents.GetRestrictions
MoveFileEvents.GetRestrictions
DeleteFileEvents.GetRestrictions
AddFolderEvents.GetRestrictions
MoveFolderEvents.GetRestrictions
DeleteFolderEvents.GetRestrictions

Installation of the security overlay 132 can include implemented events 133 in VAULT 110 using the VAULT API 115. The implementations 133 can cause VAULT 110 to contact the security overlay 132 and execute an enforcement process prior to pre-events. This can allow the security overlay 132 to implement its own project-based security restrictions, including role-based transition restrictions specific to the project. The implantations 133 can enforce the security overlay 132 security rules and include a message to display based on the rule enforcement.

The security overlay 132 includes an enforcement process 134 that executes when an implemented event occurs. If the enforcement process 134 does not generate a custom restriction, the user is allowed to perform the action.

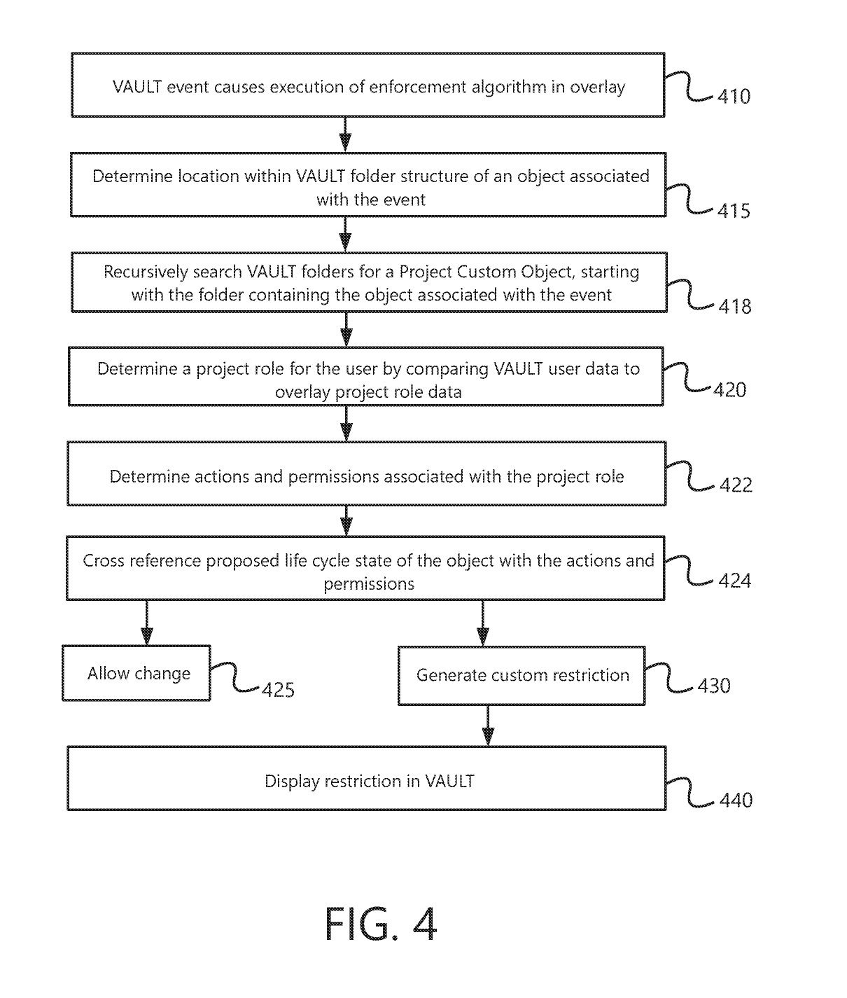

Turning to FIG. 4, an example enforcement process 134 executed by the security overlay 132 is presented for enforcing the project-based security settings of the security overlay. At stage 410, an implemented VAULT event causes the enforcement process 134 to begin executing. The event can, for example, reference an executable file that kicks off the process. In one example, the executable is a DLL plugin that runs within a VAULT process on the user's computing device 250. In another example, the event instantiates a new instance of an enforcement object that executes the enforcement process 134.

At stage 415, the enforcement process 134 determines the location within the VAULT folders 122 where the action object (e.g., file) being acted on is located. This can yield the full file path to the object associated with the event.

At stage 418, the enforcement process 134 recursively searches the file path for an instance of a project custom object. This includes starting by examining the current folder of the full file path to determine if the folder includes a link to an instance of a project custom object. If a link to a project custom object instance is found, that instance is identified as representing the project.

If no instance of a project custom object is found, the parent folder is searched next. The enforcement process 134 can continue to work its way up through parent folders until the project custom object instance is found. Once a project custom object instance is found, it is determined to be the applicable project. However, if the enforcement process 134 does not find a project custom object instance, the enforcement process 134 stops. That can occur, for example, when the security overlay 132 has not yet set up project-based security for a project to which the event relates.

Once the project custom object instance is found, at stage 420 the processor can determine a project role for the currently logged-in VAULT 110 user by locating that user in the project role to user mapping data in the project custom object instance. Locations where the user appears within the mapping data can indicate the roles associated with that user. The applicable project role permission data can be downloaded, deserialized, and cached for faster access in the future.

For each role, at stage 422 the processor can determine actions and permissions for that role. For actions that do not involve life cycle state changes, the current user is checked against the project role permission data to determine if the user is allowed to perform the action (that generated the event). Example actions that do not require life cycle state changes are listed below in Table 2:

TABLE 2

AddFileEvents
AddFolderEvents
MoveFolderEvents
DeleteFolderEvents

For these events, if the user has permission, the enforcement process stops (e.g. at step 425). Otherwise, a custom restriction is raised, as explained with regard to step 430.

For life cycle events, the process continues at step 424. Example life cycle driven events are included below in Table 3:

TABLE 3

UpdateFileLifecycleStateEvents
UpdateCustomEntityLifecycleStateEvents
CheckoutFileEvents
CheckinFileEvents
DownloadFileEvents
MoveFileEvents
DeleteFileEvents

For these events, at step 424 the processor retrieves the current life cycle state attached to the action object (e.g., file). The processor then cross-references the current state against the stored project role permissions data. (As previously explained, the project role permissions data can be entered by the administrative user in connection with the user interface 330 of FIG. 3B.) The current user can be checked against the project role permission data to determine if the user is allowed to perform the action (e.g., from Table 3) based on the current life cycle state of the file. If the user is allowed, the change is allowed at stage 425. Otherwise, a custom restriction is generated at step 430.

If the action is UpdateFileLifeCycleStateEvents or UpdateCustomEntityLifecycleStateEvents, then the proposed life cycle state (that the user is attempting to change the file to) is examined. The proposed life cycle state can be cross referenced with the project role permission data to determine if the current VAULT 110 user is in a project role that permits the change. If they are allowed, the change is allowed at stage 425. Otherwise, a custom restriction is generated at stage 430.

At stage 430, the enforcement algorithm passes back (to VAULT 110) the object causing the restriction and a message associated with the restriction. The object is the file, folder, or custom object that invoked the start of the enforcement process. The message can be a string, such as “You cannot perform this action because your project role does not allow it.”

Upon receiving the object identifier and message, VAULT 110 can display this information to the user on the user device 250 at stage 440.

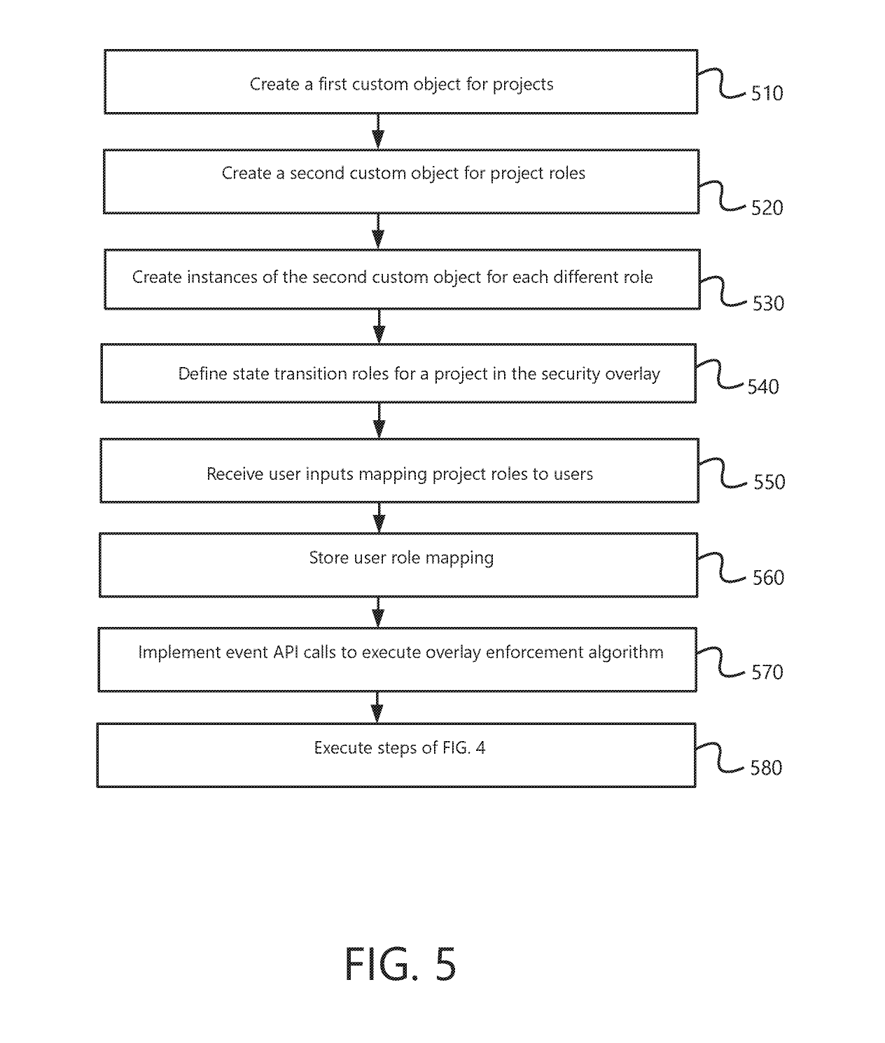

FIG. 5 is an example method for setting up the security overlay to operate with a CAD file management system, such as VAULT 110. At stage 510, a first custom object for projects is created. The security overlay 132 can detect that no project custom object yet exists and create the custom object in one example. At stage 520, the same can be done for a project roles custom object.

Using a security overlay 132 user interface, a user can create new projects and roles. Each new project creates a new instance of the project custom object. At stage 530, the security overlay 132 creates instances of the project role custom object for each new role added.

At stage 540, an administrative user is presented with a user interface to define which roles can perform which state transitions within a project (e.g., as discussed with regard to FIG. 3B). A custom drop-down menu item can be provided within VAULT for executing the security overlay user interface. For example, installation of the security overlay 132 can include adding a custom menu item through methods in the VAULT 110 API 115.

The security overlay 132 can receive user inputs in the user interface mapping project roles to users at stage 550. Then at stage 560, the mapping data is stored in VAULT 110. It can be stored in a special custom storage area in one example, such as in an instance of a project custom object.

At stage 570, VAULT 110 API 115 events are implemented to redirect to the security overlay 132. The implementation can include placing code within VAULT 110 that configures the events to call the enforcement procedure of the security overlay 132. The enforcement procedure can initiate execution of the enforcement process.

At stage 580, the enforcement process executes the stages described with regard to FIG. 4.

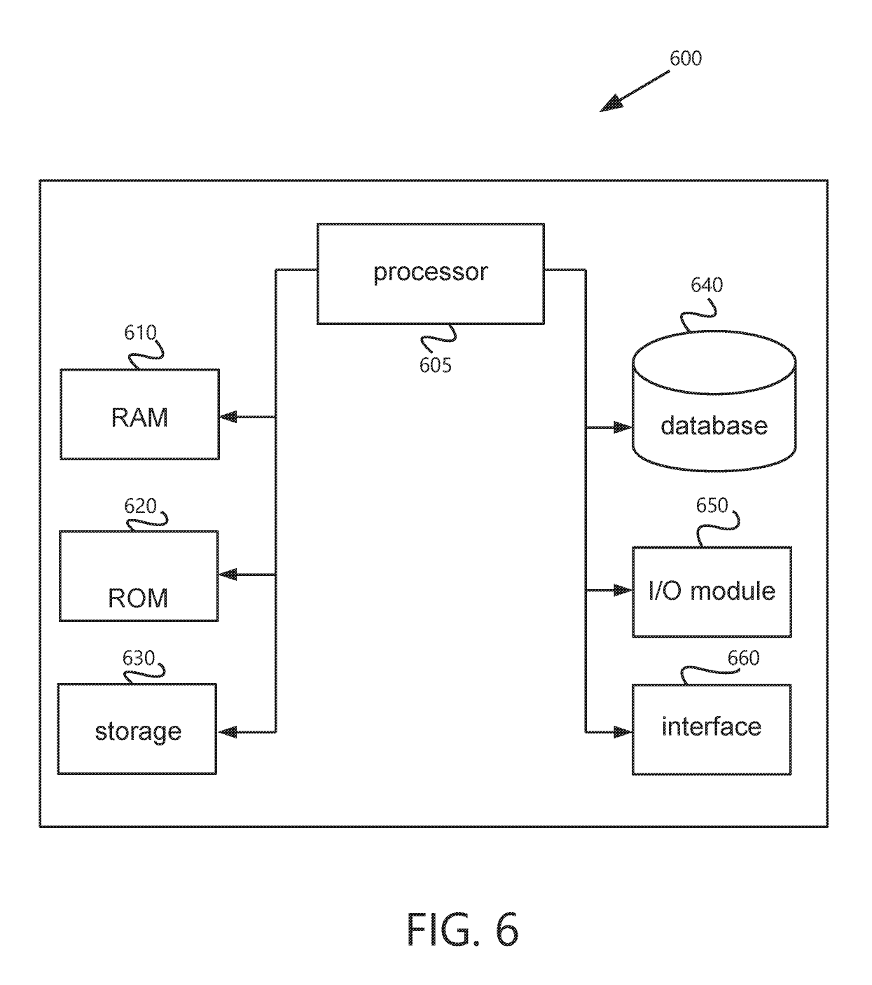

FIG. 6 depicts an exemplary processor-based computing system 600 representative of the type of computing system that may be present in or used in conjunction with a server 205 or device 250 of FIG. 2. Continuing with FIG. 6, the computing system 600 is exemplary only and does not exclude the possibility of another processor- or controller-based system being used in or with one of the aforementioned components. Additionally, a server 205 or user device 250 need not include all the system hardware components in an embodiment.

In one aspect, system 600 may include one or more hardware and/or software components configured to execute software programs, such as software for storing, processing, and analyzing data. For example, system 600 may include one or more hardware components such as, for example, processor 605, a random access memory (RAM) module 310, a read-only memory (ROM) module 620, a storage system 630, a database 640, one or more input/output (I/O) modules 650, and an interface module 660. Alternatively and/or additionally, system 600 may include one or more software components such as, for example, a computer-readable medium including computer-executable instructions for performing methods consistent with certain disclosed embodiments. It is contemplated that one or more of the hardware components listed above may be implemented using software. For example, storage 630 may include a software partition associated with one or more other hardware components of system 600. System 600 may include additional, fewer, and/or different components than those listed above. It is understood that the components listed above are exemplary only and not intended to be limiting.

Processor 605 may include one or more processors, each configured to execute instructions and process data to perform one or more functions associated with system 600. The term “processor,” as generally used herein, refers to any logic processing unit, such as one or more central processing units (CPUs), digital signal processors (DSPs), application specific integrated circuits (ASICs), field programmable gate arrays (FPGAs), and similar devices. As illustrated in FIG. 6, processor 605 may be communicatively coupled to RAM 610, ROM 620, storage 630, database 640, I/O module 650, and interface module 660. Processor 605 may be configured to execute sequences of computer program instructions to perform various processes, which will be described in detail below. The computer program instructions may be loaded into RAM for execution by processor 605.

RAM 610 and ROM 620 may each include one or more devices for storing information associated with an operation of system 600 and/or processor 605. For example, ROM 620 may include a memory device configured to access and store information associated with system 600, including information for identifying, initializing, and monitoring the operation of one or more components and subsystems of system 600. RAM 610 may include a memory device for storing data associated with one or more operations of processor 605. For example, ROM 620 may load instructions into RAM 610 for execution by processor 605.

Storage 630 may include any type of storage device configured to store information that processor 605 may need to perform processes consistent with the disclosed embodiments.

Database 640 may include one or more software and/or hardware components that cooperate to store, organize, sort, filter, and/or arrange data used by system 600 and/or processor 605. For example, database 640 may include user-specific information, including password information, along with the custom objects and customization data. Alternatively, database 640 may store additional and/or different information. Database 640 may also contain a plurality of databases that are communicatively coupled to one another and/or processor 605, which may be one of a plurality of processors utilized by server 630.

I/O module 650 may include one or more components configured to communicate information with a user associated with system 600. For example, I/O module 650 may include a console with an integrated keyboard and mouse to allow a user to input parameters associated with system 600. I/O module 650 may also include a display including a graphical user interface (GUI) for outputting information on a monitor. I/O module 650 may also include peripheral devices such as, for example, a printer for printing information associated with system 600, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 660 may include one or more components configured to transmit and receive data via a communication network, such as the Internet, a local area network, a workstation peer-to-peer network, a direct link network, a wireless network, or any other suitable communication platform. For example, interface 660 may include one or more modulators, demodulators, multiplexers, demultiplexers, network communication devices, wireless devices, antennas, modems, and any other type of device configured to enable data communication via a communication network.

Other embodiments of the invention will be apparent to those skilled in the art from consideration of the specification and practice of the invention disclosed herein. It is understood that the security overlay can operate as a plugin with VAULT or any other CAD file management system. It is further understood that the files being managed can be any type of file (e.g., PDF, DOC, etc.) within VAULT or another file management system, not just CAD files. The examples herein can apply to any file type. It is intended that the specification and examples be considered as exemplary only, with a true scope and spirit of the invention being indicated by the following claims.

What is claimed is:

1. A security overlay for enforcing project-based security in an existing computer-aided design management system, the security overlay comprising:
a non-transitory computer-readable medium containing instructions;
a processor in communication with the computer-readable medium, the processor performing stages including:
creating a first custom object for defining projects and second custom object for defining project roles, the first and second custom objects being stored in the computer-aided design management system;
creating an instance of the first custom object to define a project;
receiving, at a user interface, permitted roles for performing a plurality of state transitions within the project;
mapping project roles to users and storing mapping information in the first custom object;
in response to an event relating to an action object occurring in the existing computer-aided design management system, executing an enforcement process with the processor, the enforcement process determining that the event correlates to the project by locating a link to the instance within a file path for the action object; and
sending a custom restriction method to the computer-aided design management system based on at least one role within the permitted roles being associated with a user that triggered the event.

2. The security overlay of claim 1, wherein determining that the event correlates to the project includes recursively searching folders in the file path of the action object, starting in the folder where the action object is located.

3. The security overlay of claim 1, the stages further including determining the user's at least one role within the project by reading mapping data in the instance.

4. The security overlay of claim 3, the stages further including:
comparing the at least one role to information in a project role object instance to determine permissible actions associated with the at least one role; and
comparing the event to the permissible actions to determine whether the user is permitted to carry out the event on the action object.

5. The security overlay of claim 1, wherein the event is a life cycle event, and wherein the stages further include:
retrieving a current life cycle state attached to the action object; and
determining whether a transition state is permitted for the at least one role associated with the user for the project based on configuration information stored in computer-aided design management system.

6. The security overlay of claim 5, wherein the configuration information is part of the mapping information in the instance.

7. The security overlay of claim 5, wherein the configuration information is part of a single string, and wherein determining whether a transition state is permitted includes deserializing the string.

8. A non-transitory computer-readable medium containing instructions for providing a security overlay for enforcing project-based security in an existing computer-aided design management system, the instructions causing a processor to execute stages including:
creating a first custom object for defining projects and second custom object for defining project roles, the first and second custom objects being stored in the computer-aided design management system;
creating an instance of the first custom object to define a project;
receiving, at a user interface, permitted roles for performing a plurality of state transitions within the project;
mapping project roles to users and storing mapping information in the first custom object;
in response to an event relating to an action object occurring in the existing computer-aided design management system, executing an enforcement process with the processor, the enforcement process determining that the event correlates to the project by locating a link to the instance within a file path for the action object; and
sending a custom restriction method to the computer-aided design management system based on at least one role within the permitted roles being associated with a user that triggered the event.

9. The non-transitory computer-readable medium of claim 8, wherein determining that the event correlates to the project includes recursively searching folders in the file path of the action object, starting in the folder where the action object is located.

10. The non-transitory computer-readable medium of claim 8, the stages further including determining the user's at least one role within the project by reading mapping data in the instance.

11. The non-transitory computer-readable medium of claim 10, the stages further including:
comparing the at least one role to information in a project role object instance to determine permissible actions associated with the at least one role; and
comparing the event to the permissible actions to determine whether the user is permitted to carry out the event on the action object.

12. The non-transitory computer-readable medium of claim 8, wherein the event is a life cycle event, and wherein the stages further include:
retrieving a current life cycle state attached to the action object; and
determining whether a transition state is permitted for the at least one role associated with the user for the project based on configuration information stored in computer-aided design management system.

13. The non-transitory computer-readable medium of claim 12, wherein the configuration information is part of the mapping information in the instance.

14. The non-transitory computer-readable medium of claim 12, wherein the configuration information is part of a single string, and wherein determining whether a transition state is permitted includes deserializing the string.

15. A computer-implemented method for implementing a security overlay for enforcing project-based security on top of an existing computer-aided design management system, including:
creating a first custom object for defining projects and second custom object for defining project roles, the first and second custom objects being stored in the computer-aided design management system;
creating an instance of the first custom object to define a project;
receiving, at a user interface, permitted roles for performing a plurality of state transitions within the project;
mapping project roles to users and storing mapping information in the first custom object;
in response to an event relating to an action object occurring in the existing computer-aided design management system, executing an enforcement process with the processor, the enforcement process determining that the event correlates to the project by locating a link to the instance within a file path for the action object; and
sending a custom restriction method to the computer-aided design management system based on at least one role within the permitted roles being associated with a user that triggered the event.

16. The computer-implemented method of claim 15, wherein determining that the event correlates to the project includes recursively searching folders in the file path of the action object, starting in the folder where the action object is located.

17. The computer-implemented method of claim 15, the stages further including determining the user's at least one role within the project by reading mapping data in the instance.

18. The computer-implemented method of claim 17, the stages further including:
comparing the at least one role to information in a project role object instance to determine permissible actions associated with the at least one role; and
comparing the event to the permissible actions to determine whether the user is permitted to carry out the event on the action object.

19. The computer-implemented method of claim 15, wherein the event is a life cycle event, and wherein the stages further include:
retrieving a current life cycle state attached to the action object; and
determining whether a transition state is permitted for the at least one role associated with the user for the project based on configuration information stored in computer-aided design management system.

20. The computer-implemented method of claim 19, wherein the configuration information is part of a single string, and wherein determining whether a transition state is permitted includes deserializing the string.
